(19) United States
(12) Patent Application Publication
(10) Pub. No.: US 2026/0055527 A1
(43) Pub. Date: Feb. 26, 2026

(54) AN ELECTROWINNING CELL AND A CATHODE

(71) Applicant: LOOP HYDROMETALLURGY PTY LTD, New South Wales (AU)

(72) Inventors: David SAMMUT, New South Wales (AU); Adam RANDALL, New South Wales (AU)

(73) Assignee: LOOP HYDROMETALLURGY PTY LTD, New South Wales (AU)

(21) Appl. No.: 18/998,909

(22) PCT Filed: Jul. 27, 2023
(86) PCT No.: PCT/AU2023/050694

§ 371 Date: Jan. 27, 2025

(30) Foreign Application Priority Data
Jul. 28, 2022 (AU) 2022902129

(51) Int. Cl. C25C 7/08; B23K 26/364; C25C 1/12; C25C 7/02; C25D 11/26

(52) U.S. Cl. CPC C25C 7/08; B23K 26/364; C25C 1/12; C25C 7/02; C25D 11/26

(57) ABSTRACT

Disclosed herein is a halide electrowinning cell comprising a cathode (e.g. a titanium cathode) and an anode configured for immersion in an electrolyte comprising a metal halide. In use, passing an electrical current through the cell causes metallic dendrites to be electrowon at the cathode. The cell also comprises one or more wipers configured such that a relative movement of the cathode with respect to the one or more wipers causes the electrowon dendrites to be scraped off the cathode whilst immersed in the electrolyte, as well as a driver configured to continually move the cathode relative to the one or more wipers.

### TECHNICAL FIELD

The present invention relates to halide electrowinning cells and, in one particular form, to halide electrowinning cells for recovering copper from a process liquor.

### BACKGROUND ART

Electrowinning of metals at the cathode of electrowinning cells can be used to recover high grade metals from solutions containing dissolved metal species. For example, in conventional hydrometallurgical copper extraction processes, sulphate-based lixiviants are used to leach copper from a copper concentrate, with flat sheets of copper-containing metal being electrowinnable from the resultant copper sulphate-containing pregnant liquor. The flat sheets of electrowon high grade copper metal are scraped off the cathode and taken for final processing. Sulphate-based processes are, however, highly sensitive to certain contaminants and suffer from other problems such as requiring either relatively high pressure and temperature, or relatively long residence times.

Halides are also good lixiviants (better, in fact, than sulphate), and halide leaching of copper-containing concentrates is comparatively easy, fast and thorough (compared to sulphate-based processes). Copper in the process liquor in such systems is also in the form of Cu⁺, requiring only one electron for reduction to copper metal, and hence the process has reduced energy requirements (i.e. compared to sulphate-based processes, where reduction of Cu²⁺ requires two electrons). However, halide electrowinning processes can result in the formation of chlorine gas, which significantly complicates the process. Furthermore, handling of the crystalline dendrite form of copper metal produced during direct electrowinning in halide-based processes has, to date, been problematic. For these reasons, at least, only small and niche applications of halide electrowinning processes have ever been commercialised.

It would be advantageous to provide halide electrowinning cells and components thereof which can utilise the advantages of halide-based extraction processes, but in which the electrowon metal dendrites are processed in a manner that is compatible with industrial scale operation.

### SUMMARY OF INVENTION

The inventors of the invention the subject of the present application have discovered that it is possible to control the formation and recovery of copper dendrites on the cathode of halide electrowinning cells. The inventors believe that their discovery has the potential to result in commercially viable halide electrowinning cells, which are operable on an industrial scale for the continuous recovery of metals, such as copper, directly from metal-containing halide electrolytes.

In a first aspect, the present invention provides a halide electrowinning cell comprising a cathode (e.g. a titanium cathode) and an anode configured for immersion in an electrolyte comprising a metal halide. In use, passing an electrical current through the cell (i.e. between the cathode and the anode) causes metallic dendrites to be electrowon at the cathode. The cell also comprises one or more wipers configured such that a relative movement of the cathode with respect to the one or more wipers causes the electrowon dendrites to be scraped off the cathode, whilst immersed in the electrolyte. The cell also comprises a driver configured to continually move the cathode relative to the one or more wipers.

In a second aspect, the present invention provides a method for recovering a metal from an electrolyte comprising a metal halide. The method comprises passing an electrical current through the halide electrowinning cell of the first aspect of the present invention (i.e. in which the electrolyte is contained) and collecting the metallic dendrites scraped off the cathode.

The unique configuration and operation of the halide electrowinning cell of the present invention, in which the cathode is continually moved relative to the wiper(s) in use, has been found to result in an appreciable quantity of dendrite growth (copper dendrites, in the trialled embodiments discussed below, although the inventors expect that the invention would also be useful for other metals including lead, zinc and nickel) on the cathode at any given time. Given the very high surface area of the dendrites, and that the incoming current is fixed, this means that the actual current density at the growth sites will be reduced by a substantial margin (perhaps 2 or 3 orders of magnitude, or more), such lower current density being expected to improve the quality of the copper product.

Further, the continuous mechanical action of the wiper(s) on the cathode provides a continual “rain” of relatively small dendrites, which fall to the bottom of the cell. Such a product is more easily recoverable than is the case for many existing processes, including the so-called Intec Copper Process, where the cathodes are only periodically wiped (e.g. every 20-60 minutes), with the ‘dumped’ copper dendrites having an extremely wide range of sizes and angular configurations that make them rather challenging to recover. Other problems with the Intec Copper Process include the risk of the electrowon dendrites bridging to the anode, problems with effective scraping, as well as radical changes in the electrical profile and cell voltage pre- and post-scraping. Furthermore, the cathode not “breaking the surface” when the electrowon dendrites are scraped off in use of the present invention means that the metal dendrites (and the wetted cell components) are also not exposed to air, lowering oxygen contamination of the final product and further contributing to an improvement in cell efficiency.

In some embodiments, the cathode may be configured to remain substantially immersed in the electrolyte at all times during the relative movement with respect to the one or more wipers. Advantageously, moving the cathode in a manner where it does not “break the surface” has been found to significantly reduce oxygen ingress, which can re-oxidise the catholyte and reduce the efficiency of the cell.

In some embodiments, the one or more wipers comprise opposing wipers configured to receive the cathode therebetween. Such a “pinching” configuration of wipers may result in a more complete removal of the dendrites than if only one wiper is used or if the wipers are offset with respect to each other.

In some embodiments, the one or more wipers may be static, with the cathode moving relative to the wipers. By fixing the wipers in place and having the cathode move relative to them (e.g. between them), the wipers can be made more robust. Such robustness may be advantageous in removing tenacious metal dendrites, with the wipers being less likely to break or bend when forced into contact with the metal dendrites. Furthermore, if the cathode is the moveable component, the inventors have found that the wipers and anode chambers of the cell may be integrated into a single unit, resulting in a significantly narrower profile compared to that which would be required to allow motion of the wipers (and hence a lower voltage drop between the anode and cathode, resulting in a lower power consumption).

In some of such embodiments, the cathode may move relative to the wiper(s) in a substantially horizontal movement. For example, the cathode may reciprocate between first and second positions. Such movements have been found to enable maximum efficiency of the cell, both in terms of dendrite production and footprint.

In the specific embodiments described below, for example, the halide electrowinning cell has two sets of opposing wipers which are located intermediate opposite ends of the cathode. In use, an entirety of the surface of the cathode is scraped upon reciprocation of the cathode between the first and second positions.

In some embodiments, the cathode may be a flat plate cathode (e.g. a titanium flat plate cathode). Conventional wisdom was that flat plate cathodes cannot work for halide electrowinning because it was believed that dendrites would grow in uncontrolled clusters and/or as interlinked mats that would impede wiping of the dendrites from the cathode. The inventors surprisingly discovered that this is not the case, thus enabling cathodes that have simpler configurations and mechanical operability requirements to be used than is the case for many existing cells. Flat plate titanium cathodes are, for example, simple and cheap to manufacture and refurbish. The use of flat plate cathodes in the cell also enables the anode-cathode distance to be reduced, whereupon the cell requires a lower cell voltage and has lower power consumption.

In some embodiments (as will be described in further detail below), a surface of the cathode may comprise a pattern of scratches that promotes growth of electrowon metallic dendrites in a defined configuration. The trials conducted by the inventors, some of which are described below, surprisingly and unexpectedly demonstrated that copper dendrites grew immediately and preferentially at scratches formed in the flat plate titanium cathodes used in the trials. Causing the copper dendrites to grow preferentially at specific sites on the cathode has been found to have a number of advantages, including decreased resistance to wipers and enhanced product formation.

In some embodiments, the cell may further comprise a sump into which the metallic dendrites scraped from the cathode continuously fall. The sump may, for example, comprise a pump (or similar mechanical contrivance such as a screw feeder) for removing the dendrites from the cell. Such features provide for the continual removal of the “rain” of dendrites from the cell for final processing.

In some embodiments, the cell may further comprise a cover in order to control the atmosphere within the cell and prevent potentially acid-bearing gasses from escaping the cell.

In some embodiments, the metal halide-containing electrolyte may contain two or more halide ions. The metal halide-containing electrolyte may, for example, contain Cl⁻ and Br⁻ which, as is described in international patent application no. PCT/AU1993/000311, which partly describes the Intec Copper Process and the contents of which are incorporated herein by reference, results in the formation of NaBr₂Cl (referred to as “Halex”) at the anode. NaBr₂Cl is soluble in the process liquor, has a low vapour pressure and can be recycled upstream back into the leach step of hydrometallurgical extractions. NaBr₂Cl is a more preferable by-product than chorine gas.

In some embodiments, the electrolyte comprising a metal halide may be obtained from a single or polymetallic industrial waste feedstock. In some embodiments, the electrolyte may be obtained from a mineral concentrate, tailings waste or an ore.

In a third aspect, the present invention provides a flat plate titanium cathode for use in a halide electrowinning cell. At least one of the surfaces of the cathode comprises a pattern of scratches that are deeper than a thickness of an oxide coating on the surface. The pattern of scratches is determinative of a configuration of metallic dendrites that are electrowon at the cathode in use of the halide electrowinning cell.

As noted above, conventional wisdom is that flat plate cathodes do not work for chloride (and, more generally, halide) electrowinning. It was believed that copper dendrites could not be made to grow at planned growth sites on a flat plate cathode, and that growth in uncontrolled clusters/interlinked mats would impede both wiping and washing of the produced copper. The inventors have surprisingly discovered, however, that it is possible to control where metal dendrites are electrowon on a titanium flat plate cathode during operation of a halide electrowinning cell.

In seeking alternative configurations for cathodes in their prototype halide electrowinning cell, the inventors trialled a flat plate cathode, given its mechanically simple surface to wipe. The inventors were surprised to discover that there were changes in the behaviour of the cathode over time. Specifically, scratches unintentionally formed during use of the cathode resulted in copper dendrites immediately growing preferentially at the scratches.

The discovery that led to the flat plate titanium cathode of the present invention arose following the inventors' investigations into these surface scratches. Observing the growth of copper dendrites at surface scratches that had formed on the cathode, the inventors noted that these scratches appeared to actually become preferred growth sites. The trials subsequently conducted by the inventors, some of which are described below, demonstrated that if the titanium cathode was deliberately scratched in a planned pattern, then copper dendrites would tend to grow at the scratches, which enabled the inventors to use the electrowinning cell descried below in a stable and continuous operation.

The ‘natural’ oxide coating which forms on the surface of titanium metal is typically about 3-4 μm thick. The inventors have found that such a relatively thin coating is susceptible to being scratched during use, with even light scratches being deeper than the oxide coating, which exposes the more conductive titanium and provides another pathway for electron movement (and hence a less controlled dendrite growth) on the cathode. In some embodiments, therefore, the cathode may be heat treated such that the oxide coating of the cathode has a thickness of about 30-40 μm. Such thickness of a relatively inert coating would help to maintain the configuration of metallic dendrites electrowon at the cathode.

For similar reasons, in some embodiments, the titanium cathode may be anodized, after which the oxide coating of the cathode has a thickness of about 100 μm (or more). A thicker surface coating (which is less electrically conductive) on the cathode would be less likely to be broken (thus providing alternative pathway for electron movement) during routine use of the cathode.

Thus, if the titanium cathode is either heat treated or anodised before a pattern of scratches is caused to be formed on its surface(s), then there would be two very distinct zones of oxide on the cathode's surfaces: a thick ‘enhanced’ layer across most of the cathode surface, and a thin ‘natural’ layer that re-forms inside the scratches. As the electron tunnelling should be preferential at the thinnest areas of the oxide, then the scratches would be more favoured for dendrite growth.

In some embodiments, only one side of the flat plate titanium cathode comprises the pattern of scratches. In alternative embodiments, both opposing surfaces of the cathode comprise the pattern of scratches (the same or different). Growth of the metal dendrites in use of the electrowinning cell can thus be tailored to suit many desired outcomes.

In some embodiments, the pattern may comprise a plurality of substantially parallel scratches. In some embodiments, the pattern of scratches may comprise a plurality of divergent and convergent scratches. In some embodiments, the pattern of scratches may comprise scratches having different depths and widths. These various patterns of scratches may provide advantages such as making it easier to dislodge the electrowon metal dendrites during wiping, avoiding edge effects and the like, favouring electrowinning at areas that are more frequently wiped, and causing defined portions of the cathode to have a desirable current density.

In a fourth aspect, the present invention provides a method for promoting the electrowinning of metallic dendrites in a predetermined configuration on a titanium flat plate cathode in a halide electrowinning cell. The method comprises causing a pattern of scratches to be formed on at least one surface of the cathode, the scratches being deeper than a thickness of an oxide coating on the surface.

In some embodiments, the method of the fourth aspect may further comprise heat treating the cathode before the pattern of scratches is formed on the cathode's surface(s). As described herein, such treatment can result in an oxide coating having a thickness of about 30-40 μm. Typically, oxide coatings on titanium cathodes are around 3-4 μm thick, which the inventors have found is susceptible to being scratched during use, with even the lightest of scratches being deeper than the oxide coating and thereby exposing the more conductive metal and providing another pathway for electron movement. Pathways for electron movement in addition to those provided by the pattern of scratches may adversely affect the predetermined configuration of electrowon metallic dendrites. Hence, pre-treating the titanium cathode in order to provide a thicker oxide coating can further enhance control over the position on the cathode where the metal dendrites form.

In some embodiments, the method of the fourth aspect may further comprise anodizing the cathode before causing the pattern of scratches to be formed on the cathode. As described herein, such treatment can result in an oxide coating having a thickness of up to about 100 μm.

In a fifth aspect, the present invention provides a method for obtaining a metal product from a single or polymetallic industrial waste feedstock, the method comprising extracting the metal in a hydrometallurgical extraction process including a halide lixiviant and using the halide electrowinning cell of the first aspect of the present invention to electrowin metallic dendrites.

In a sixth aspect, the present invention provides a method for obtaining a metal product from a single or polymetallic industrial waste feedstock, the method comprising extracting the metal in a hydrometallurgical extraction process including a halide lixiviant and electrowinning metallic dendrites using the halide electrowinning cell of the first aspect of the present invention, the cell comprising the titanium flat plate cathode of the third aspect of the present invention to electrowin metallic dendrites.

Other aspects, features and advantages of the present invention will be described below.

### BRIEF DESCRIPTION OF THE DRAWINGS

Embodiments of the present invention will be described in further detail below with reference to the following drawings, in which:

FIG. 1 depicts a cathode and wipers in a halide electrowinning cell in accordance with an embodiment of the present invention;

FIG. 2 depicts a halide electrowinning cell in accordance with an embodiment of the present invention;

FIG. 3 shows a flat plate cathode in accordance with an embodiment of the present invention, having horizontally arranged continuous scratched lines;

FIG. 4 shows a flat plate cathode in accordance with another embodiment of the present invention, having horizontally arranged dashed scratched lines;

FIG. 5 shows a flat plate cathode in accordance with another embodiment of the present invention, having horizontally arranged dotted scratched lines;

FIG. 6 shows a flat plate cathode in accordance with another embodiment of the present invention, having horizontally arranged square scratches;

FIG. 7 shows a flat plate cathode in accordance with another embodiment of the present invention, having zig-zag dotted scratched lines; and

FIG. 8 depicts a halide electrowinning cell in accordance with another embodiment of the present invention.

### DETAILED DESCRIPTION OF THE INVENTION

The overarching purpose of the present invention is to provide an improved halide electrowinning cell such that hydrometallurgical extraction processes using halide-based electrowinning processes are a commercially viable alternative to the conventional sulphate-based processes. The present invention thus provides a halide electrowinning cell comprising a cathode (e.g. a titanium cathode) and an anode configured for immersion in an electrolyte comprising a metal halide. In use, passing an electrical current through the cell causes metallic dendrites to be electrowon at the cathode. The cell also comprises one or more wipers configured such that a relative movement of the cathode with respect to the one or more wipers causes the dendrites to be scraped off the cathode whilst remaining immersed in the electrolyte, as well as a driver configured to continually move the cathode relative to the one or more wipers.

The present invention also provides a method for recovering a metal from an electrolyte comprising a metal halide, the method comprising passing an electrical current through the electrolyte contained in the halide electrowinning cell of the first aspect of the present invention and collecting the metallic dendrites scraped off the cathode.

The present invention will be described below primarily in the context of a copper extraction process for the continuous recovery of copper metal directly from a cuprous halide electrolyte. It is to be appreciated, however, that the present invention is equally applicable for use with any electrolyte comprising a metal halide that may be obtained from a single or polymetallic industrial waste feedstock. Other metals that are expected to be capable of being electrowon in use of the present invention include Pb, Zn, Ni. The electrolyte comprising a metal halide may, for example, be obtained from a mineral concentrate, tailings waste or an ore.

In halide-based hydrometallurgical extraction processes, copper extraction ‘starts’ with a leach stage, in which most minerals in the copper concentrate are broken down, and the contained metals dissolved into solution containing one or more halides. Fe, S and As are rejected as a stable hematite/elemental sulphur and ferric arsenate leach residue. The pregnant liquor is fully reduced, so that the primary metal in solution is monovalent Cu⁺, and then purified by raising the pH to 4 with limestone. Residual Fe, Bi, and other metals are rejected as a solid alkali residue, suitable for co-disposal with the leach residue. Optionally, Ag may be recovered from the purified pregnant liquor via IX, or other suitable technology.

The pregnant liquor is then fed to the catholyte of the halide electrowinning cell, where high quality copper metal is directly produced from the monovalent Cu⁺ ions. The spent catholyte passes through a permeable membrane to the anode chamber, where it is re-oxidised to Cu²⁺ and the species Cl₂Br⁻. The high oxidant anolyte may then be recycled to the end of the leach, where its strong oxidative power can be used to leach gold and PGMs, which are then recovered via IX.

In the electrowinning step, copper is electrowon onto the cathode via the following equation:

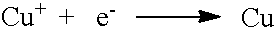

The anodes are kept in a sealed chamber, with a permeable membrane between the cathode and anode. The catholyte level is kept slightly higher than the sealed anodes, creating a mild positive pressure that keeps the liquid flow one-way from the catholyte to the anolyte.

The anolyte is then re-oxidised according to the following reactions, and the analyte overflows from the chamber into a surge tank.

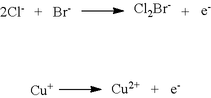

The chemical reactions which occur in the halide electrowinning cell of the present invention are as described above. The metal halide-containing electrolyte may contain two or more halide ions (e.g. Cl⁻ and Br⁻).

Each of the features of the halide electrowinning cell of the present invention will now be described.

### Cathode and Anode

The halide electrowinning cell of the present invention includes a cathode and an anode configured for immersion in an electrolyte comprising a metal halide. In use, passing an electrical current through the cell (i.e. by applying a potential difference to the cathode and anode of the cell) causes metallic dendrites to be electrowon at the cathode.

The cathode may have any suitable shape and configuration compatible with its intended uses, as described herein. Flat plate cathodes, for example, provide advantages such as being relatively simple and cheap to manufacture and refurbish. The use of flat plate cathodes in the cell also enables the anode-cathode distance to be reduced, whereupon the cell requires a lower cell voltage and has lower power consumption. Such advantages enable the production of smaller cells per cathode surface area and hence a lower voltage drop between the anode and cathode, resulting in a lower power consumption (as well as other efficiencies).

The cathodes described herein are titanium cathodes, although cathodes formed from other materials compatible with the intended uses of the present invention might also be used.

In embodiments where the cathode is a titanium cathode, one or more of the surfaces of the cathode may include a pattern of scratches which, as described herein, the inventors have found to promote growth of electrowon metallic dendrites in a pre-defined manner. The scratches may be formed on the surface of the cathode using any suitable technique, with laser etching having been used in the specific embodiments described below.

The anode in the halide electrowinning cell is essentially the same as those conventionally used in the art, having features and a structure that a person skilled in the art would be familiar with. In a specific form, for example, the anode includes an anolyte chamber, which is separated from the catholyte (including the metal halide) via a membrane. The anolyte may, for example, include Cu²⁺ and Cl₂Br. The anodes may, for example, be provide in the form of titanium mesh anodes, coated in ruthenium oxide.

### One or More Wipers

The halide electrowinning cell of the present invention also includes one or more wipers configured such that a relative movement of the cathode with respect to the wiper(s) causes electrowon dendrites to be scraped off the cathode.

The wiper(s) may take any shape and configuration compatible with their intended use. Given that electrowon dendrites can sometimes be relatively firmly adhered to the cathode, wipers having a commensurate size and/or strength would likely be more suitable for long-term use in the invention.

The wiper(s) may be positioned in the cell with respect to the cathode and each other (when there are two or more wipers), in any configuration that results in relative movement of the cathode with respect to the wiper(s) causing dendrites to be scraped off the cathode. More efficient removal of dendrites is likely to occur when there are two or more wipers, and it may be advantageous to position wipers on opposite sides of the cathode, where they effectively pinch the cathode as it passes therebetween.

The one or more wipers may, in some embodiments, be held in a fixed position in the cell, with the cathode being the component that is moved relative to the one or more wipers. The inventors expect that such configurations will be stronger and less susceptible to mechanical issues when debriding stubborn dendrites. It will be appreciated, however, that configurations in which the wiper moves with respect to a stationary cathode, or in which both the wiper and cathode can move, could still achieve the advantageous effects of the present invention.

The materials used to form the wipers should be non-conductive, inert with respect to the conditions within the cell, and have a balance of mechanical resilience and durability. It is within the ability of a person skilled in the art to determine an appropriate material for use in this regard. In the embodiments described below, the wipers are made from polyurethane blocks.

### Driver

The halide electrowinning cell of the present invention also includes a driver configured to continually move the cathode relative to the one or more wipers. Any suitable driver may be used to achieve this affect, a specific embodiment of which is described below.

Advantageously, the continual movement of the cathode relative to the one or more wipers results in a continuous removal of the dendrites electrowon on the cathode. This results in the effective surface area of the cathode (i.e. including that of the dendrites) remaining approximately consistent, at least during steady state operation of the cell, which is expected to result in a metal product having a better quality and morphology. In some embodiments, the relative rate of movement of the cathode/wiper(s) may be controlled such that an effective surface area of the cathode and electrowon dendrites is maintained, which produces a desired nominal current density at the cathode's surface (i.e. including the dendrites), and hence a characteristic product. As would be appreciated, current density selection is an important part of electrowinning cell design. Higher nominal current density allows the production of more metal per unit area of cathode. For a given number of cathodes per cell, higher nominal current (and therefore current density) reduces the number of cells required for total metal production.

In use of the halide electrowinning cell, the cathode may move relative to the one or more wipers in a substantially horizontal movement. Such a movement results in the cathode never “breaking the surface” of the electrolyte which, unless an inert atmosphere was present, would expose it to atmospheric oxygen and thereby cause problems such as reducing the efficiency of the cell and contaminating the product. As would be appreciated, despite being (and remaining) substantially immersed in the electrolyte in use, at least a small portion of the cathode would reside above the surface of the electrolyte in order to provide for the electrical connections to the cathode. However, the vast majority of the cathode is intended to be immersed in use, including particularly the “wet” portion of the cathode on which the electrowon dendrites reside.

Perhaps the simplest mechanical configuration the inventors envisage to achieve a substantially horizontal movement is to configure the cathode such that it reciprocates (e.g. horizontally) between first and second positions. In these embodiments, moving the cathode from the first position to the second position may cause the wiper(s) to pass over effectively the entire surface of the cathode, scraping off all of the dendrites electrowon since the previous pass.

The range of movement of the cathode may be such that one wiper (or opposing wipers) can remove all dendrites. Alternatively, two (or more) sets of opposing wipers may be provided, located intermediate opposite ends of the cathode, whereby an entirety of the surface of the cathode is scraped upon reciprocation of the cathode between the first and second positions.

### Other Features

The halide electrowinning cell of the present invention may also include other features that provide an enhanced functionality to the invention.

In some embodiments, for example, the cell may also include a sump or a trough into which metallic dendrites scraped from the cathode continuously fall. Such a sump may include a pump or screw feeder (or the like) for removing the dendrites from the cell. In use, such features provide for a continuous removal of the “rain” of dendrites from the cell for final processing.

In some embodiments, for example, the cell may also include a cover for the cell. Such a cover may assist to control the atmosphere within the cell, as well as to prevent potentially noxious gasses from escaping the cell. In some embodiments, for example, a sawtooth cell cover may be placed overtop the cell to limit air ingress and escape of gaseous by-products. The lid structure and sawtooth locations may be designed such that condensation will fall between cell components to limit incidental corrosion.

Electrical connections would be provided where necessary to carry electricity to and from the cell. For example, copper anode and cathode bus bars may be provided to carry electricity to the cell.

Other components may be provided in order for the cell to be flushed with nitrogen (or another non-reactive gas) to displace oxygen or to provide for off-gas neutralisation. Components for dendrite washing and drying may also be provided for the material recovered from the cell's sump.

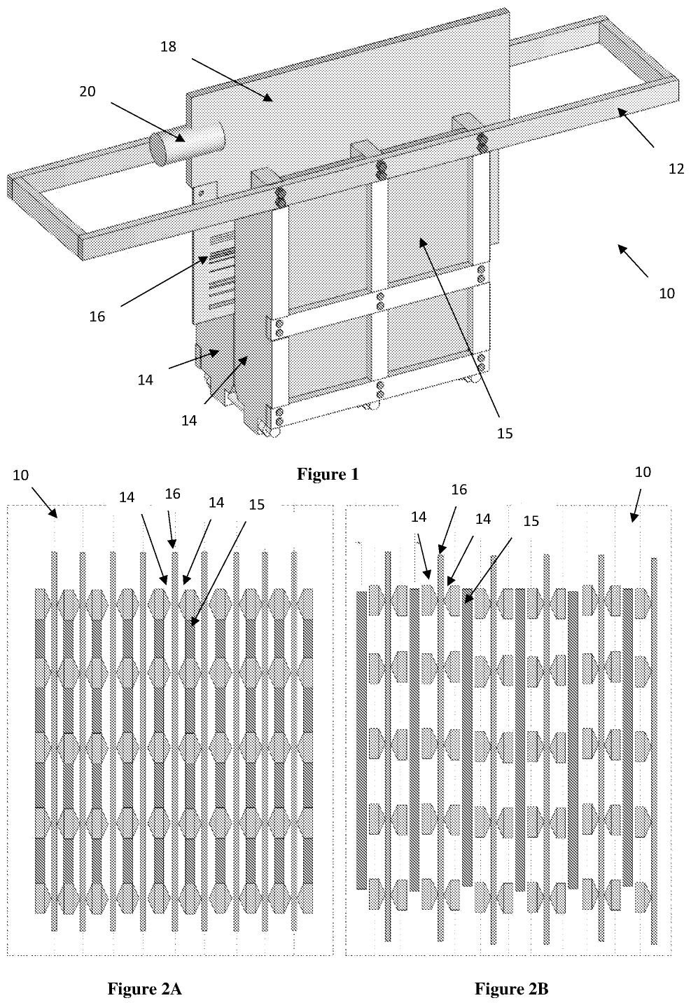

A working prototype of a halide electrowinning cell in accordance with a specific embodiment of the present invention will now be described with reference to FIGS. 1 and 2.

As noted above, one of the key features of the present invention is the ‘Horizontal cathode in motion’ concept. Essentially, the inventors recognised that halide electrowinning cells of which they are aware, such as that trialled by Intec Limited in the Intec Copper Process, involve complicated machinery that would require substantive operations, maintenance and repairs. Furthermore, the design of such cells requires that the cathode regularly ‘break surface’ in order for the electrowon dendrites to be scraped off for collection, resulting in an ongoing issue of oxygen ingress, re-oxidising of the catholyte and reduction in the efficiency of the cell.

The inventors have re-imagined the configuration of halide electrowinning cells and, as a result of their ingenuity, have invented a cell changed in respect of both the direction of movement (from vertical to horizontal) and the component of the cell that moves (from the wiper mechanism to the cathode itself).

FIG. 1 depicts a working prototype of an electrowinning cell 10 constructed by the inventors, in which an acrylic tank (ca. 90L, not shown) was used to contain the electrolyte (also not shown) and other cell components. Rigid support struts 12 are provided around the periphery of the tank, from which polyurethane wiper blocks 14 built onto an outer surface of an anode chamber 15 project. A flat plate titanium cathode 16 is positioned between opposing wiper blocks 14, 14 and is suspended from a UHMWPE (ultra-high molecular weight polyethylene) header 18 that was affixed to two bearings (not shown) that move horizontally within two tracks (also not shown). A rod 20 on one (or both) sides of the header 18 is operable to drive the cathode 16 between the wiper blocks 14, 14 in a linearly reciprocating movement between a leftmost position and a rightmost position (with reference to the configuration shown in FIG. 1). Motion of the header 18 and cathode 16 was enacted via an actuator connected to both a timing device and a variable voltage DC power supply (not shown). Both the frequency and force of movement could be varied.

In the prototype depicted in FIG. 1, the wipers 14, 14 are fixed in place and the cathode 16 caused to move horizontally between them in a linearly reciprocating manner. This configuration allows the wipers to be made very robustly. Indeed, the wipers used in the prototype were blocks with 40 mm cross-section.

As shown in FIGS. 1 and 2A, as the flat cathode 16 is the component that moves, then the wiper blocks 14 and anode chambers 15 can be integrated into a single unit. This offers a significantly narrower profile compared to that shown in FIG. 2B, where additional space would be required to allow motion of the wiper. In FIG. 2A, the distance between adjacent cathodes 16, 16 is expected to be about 115 mm, but in the configuration shown in FIG. 2B this is expected to be about 170 mm. As would be appreciated, the cell configuration of FIG. 2B would provide for a cell having a reduced footprint, enabling more cells to be included in a given space, or smaller footprints to be utilised.

The cathode 16 is configured to move slowly, but continuously, so that there is an appreciable quantity of copper dendrite growth on the cathode (not shown) at any given time. Given the very high surface area of the dendrites and that the incoming current is fixed, the effective current density at the growth sites will be reduced by a substantial margin—easily 2 or 3 orders of magnitude, and potentially considerably more. Fundamental electrowinning theory shows that lower effective current density improves the quality of the copper product, this being one of several key factors controlling whether or not ‘boundary layers’ will form close to the cathode surface. It has been shown that both the morphology of the copper product (crystalline dendrites) and their chemical purity are substantially enhanced as dendritic growth lowers the effective current density.

By contrast, the existing niche halide electrowinning cell of which the inventors are aware relies on periodic wiping (typically every 20-60 minutes). At each wipe, the entire load of copper dendrites is dumped to the bottom of the cell, and the cell's electrical parameters would spike dramatically. The effective current density would increase dramatically, and the cell voltage would spike, resulting in a product having highly variable morphology. The continuous wiping of the present invention eliminates this operational variability, giving significantly greater cell stability.

The present invention also provides a flat plate titanium cathode for use in a halide electrowinning cell. At least one of the surfaces of the cathode includes a pattern of scratches that are deeper than a thickness of an oxide coating on the surface. The pattern is determinative of a configuration of metallic dendrites that are electrowon at the cathode in use of the halide electrowinning cell.

The inventors' discovery that dendrites can be electrowon at specific locations on the cathode, and perhaps even in specific configurations at specific locations on the cathode, is of enormous potential benefit in the context of electrochemical cells such as those described herein. For example, scratch patterns can be designed to improve the ease with which the wipers can scrape the dendrites off the cathode, or to help reduce the growth of dendrites at the edges of the cathode.

The scratches may be provided in any appropriate form, with nothing more than simple trial and experimentation being required (in light of the teachings contained herein) to devise an appropriate pattern for any given cell. Either or both of the opposing surfaces of the cathode may include a pattern of scratches, and the opposing patterns may be the same or different.

The pattern may include a plurality of substantially parallel scratches, extending longitudinally or (less likely) laterally across the surface of the cathode. The pattern may include a plurality of divergent and convergent scratches, which may facilitate easier removal of the electrowon dendrites due to them not presenting a linear barrier to a vertically aligned wiper (e.g. as would be the case with a laterally arranged scratch), for example. The pattern may include scratches having different depths and widths, where such alters factors like the rate of growth or configuration of the electrowon dendrites.

As noted above, titanium electrodes have an oxide coating on their surface which is typically about 3-4 μm thick. The inventors have discovered that scratches made in this coating result in preferred pathways for electron movement and hence a preferred dendrite growth.

In some embodiments, the effect of the pattern of scratches may be enhanced by increasing the thickness of a relatively non-conductive oxide layer on the surface of the titanium electrode. In this manner, scratches on the surface of the electrode, which routinely occur during operation of the cell, are less likely to disrupt the intended effect of the pattern of scratches. For example, the cathode may be anodized before use, after which the oxide coating of the cathode has a thickness of about 100 μm or more. Alternatively, the cathode may be heat treated before use, after which the oxide coating of the cathode has a thickness of 30-40 μm. A thicker surface coating (which is less electricity conductive) on the cathode would be less likely to be damaged (thus providing alternative pathway for electron movement) during routine use of the cathode.

Also provided is a method for promoting the electrowinning of metallic dendrites in a predetermined configuration on a flat plate titanium cathode in a halide electrowinning cell. The method comprises causing a pattern of scratches to be formed on at least one surface of the cathode, the scratches being deeper than a thickness of an oxide coating on the surface.

For the reasons described above, this method may further comprise anodizing the cathode before the pattern of scratches is formed on the cathode's surface(s). Alternatively, the method may further comprise heat treating the cathode before the pattern of scratches is formed on the cathode's surface(s).

As discussed above, conventional wisdom was that flat plate cathodes cannot work for chloride electrowinning. In simple summary, it was generally believed (including by the present inventors) that copper dendrites could not be made to grow at planned growth sites on a flat plate cathode, and that growth in uncontrolled clusters/interlinked mats would impede both wiping and washing of the product copper. A key discovery underpinning the present invention goes against such conventional wisdom.

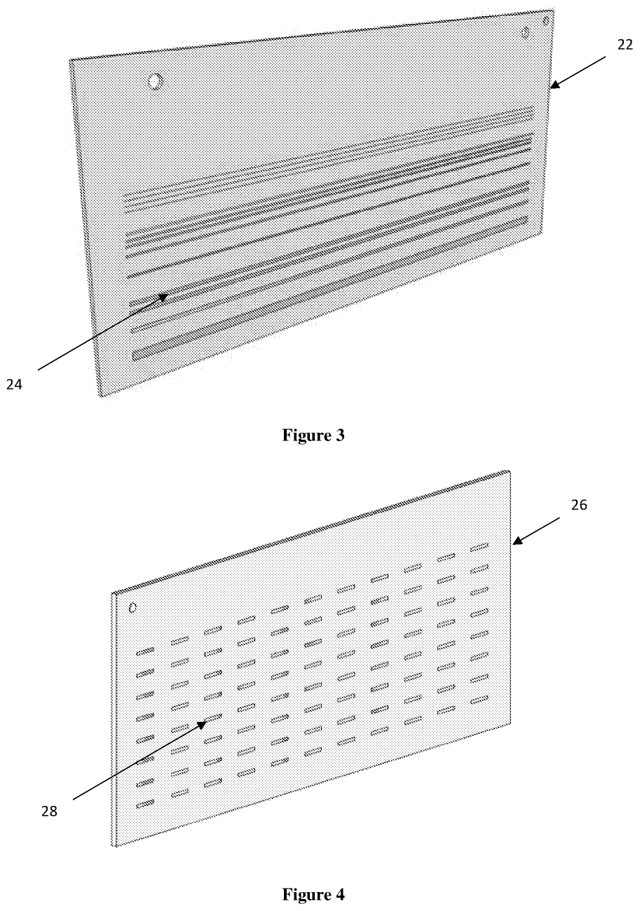

A prototype flat plate cathode 22, depicted in FIG. 3, was produced using a relatively thick titanium plate (3 mm instead of the usual 1 mm), selected for greater rigidity. Scratches were formed on the surface by laser-etching to an estimated depth of ˜0.1 mm, in lines of varying thickness (˜1 mm to 5 mm). Scratch lines 24 were grouped into clusters with varying distance between the lines (2.5 mm to 10 mm), and each cluster was spaced 20 mm apart.

The intent with cathode 22 was both to test the hypothesis that copper would grow preferentially in the lines 24, and at the same time study the effect of spacing on the inter-growth of copper dendrites between the lines.

A second prototype (not shown) was also prepared on which the lines were angled at 30°. This configuration of lines was expected to make it easier to dislodge the electrowon copper dendrites during wiping.

In the trials conducted by the inventors, it was immediately apparent that the concept was valid. Copper grew preferentially, albeit not exclusively, in the lines 24. The growth was sufficiently targeted that it can be said to have grown where designated/preferred.

No means was found to quantify the effect of the different scratch widths and spacings. However, the dendrite growth tended to ‘mat’ more on the thicker and more closely spaced scratches. Subject to further investigation, the inventors expect that the narrower growth scratches were preferred (1-2 mm), and that these lines should be spaced 10-12 mm apart. This appeared to give the best observed separation of the dendritic growth, which is anticipated to facilitate copper removal from the cathode.

It is noted that dendritic growth also occurred at the edges of the cathode. This is a well-known phenomenon, which could be prevented via the application of wax, although this might not be necessary (particularly after a steady state operation has been reached) as dendritic growth at the edges caused no apparent problems in the operation of the test cell.

It is worth noting that there was no observed change over time with the difficulty of removing copper from the lines scratched in the cathode's surfaces. From the start of prototype testing to the end, it was observed that removal of the copper on the ‘unscratched’ areas between the etched lines was easy—copper would come off with a simple wipe of the hand.

Copper within the scratches 24 tended to vary. Some areas would come off easily with the same finger pressure. Other areas on the same etched line could prove more difficult, where harder finger pressure or light pressure with a fingernail would be required to dislodge the copper growth. Nothing stronger than this was required.

The copper tended to come off much more easily if the wiping force was applied perpendicularly to the line of copper growth, which indicates that the angled lines of the second prototype (not shown) might help favour copper wiping.

The wiper utilised in these tests was a simple flat block, tapered to a flat point about 3 mm wide at the tip. The apparatus was set up with a loose spacing between the wiper and cathode, approximately 2 mm either side of the cathode.

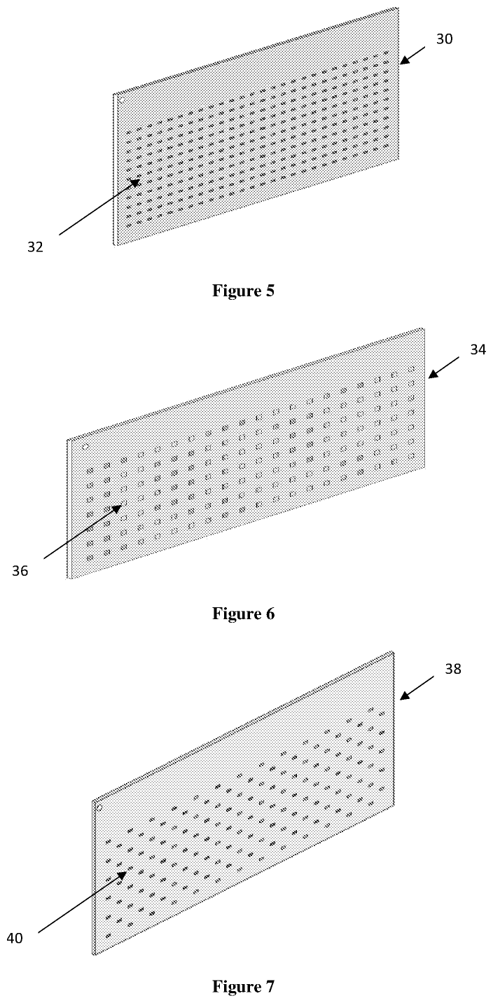

Alternative cathode designs are shown in FIGS. 4 to 7. In FIG. 4, the cathode 26 has a pattern of scratches in the form of dashed lines 28 that are laterally and substantially horizontally arranged. In FIG. 5, the cathode 30 has a pattern of scratches in the form of dotted lines 32 that are laterally and substantially horizontally arranged. In FIG. 6, the cathode 34 has a pattern of scratches in the form of squares 36 that are laterally and substantially horizontally arranged. In FIG. 7, the cathode 38 has a pattern of scratches in the form of zig zag dotted lines 40.

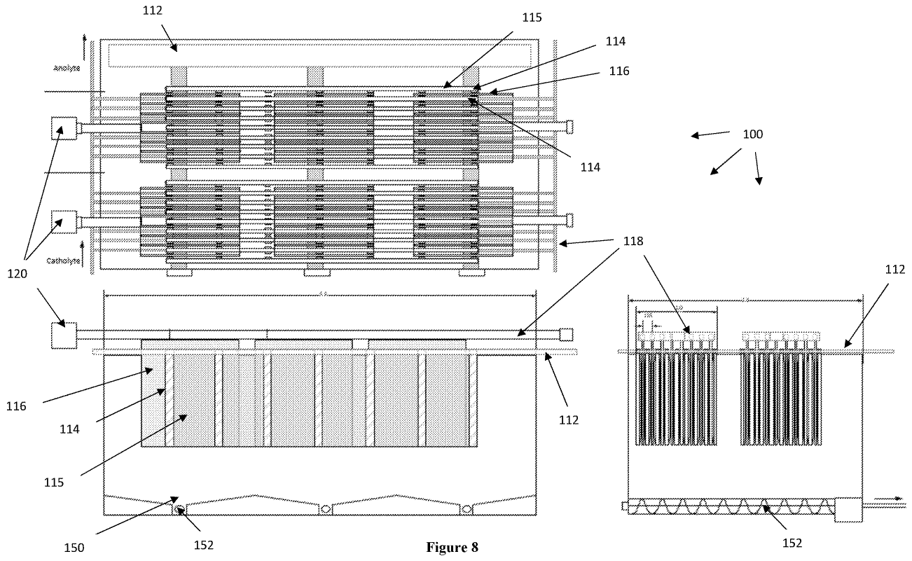

A conceptual diagram of a halide electrowinning cell in accordance with an embodiment of the invention is shown in FIG. 8. FIG. 8 shows plan, side and end elevations of halide electrowinning cell 100.

The cell tank is a polycrete rectangle, provisionally 5.3 m×2.9 m, ˜1.9 m deep. Underneath the cathodes 116 are a series of ‘sawtooth’ walls designed to allow falling copper dendrites to drop into sumps 150 for removal. These sumps 150 are set perpendicular to the horizontal motion of the cathodes 116.

Flat plate titanium cathodes 116, arranged in banks of eight cathodes, are connected in a structural frame 118 at the top and also to electrical bus bars 117. Each cathode 116 is 1.2 m×1 m and is laser etched on both sides to form a pattern of scratched preferential copper growth sites. The banks are designed to be removable from above for maintenance and periodic refurbishment. Three banks of cathodes 116 are connected in a ‘train’ with double-acting hydraulic rams 120 set outside the cell. These move the cathode banks horizontally, with a 0.6-1.2 m travel distance.

Titanium mesh anodes 115, coated in ruthenium oxide, are set into fixed inert frames (provisionally UHMWPE, but multiple plastics are suitable) with flat bladed wipers 114 set every 300 mm along the anode frame, with permeable membrane in between the wipers. The anode/wiper frames 115 extend the full width of the cell 100, with the anodes provisionally being ˜3.6 m×˜1 m inside the frames. There are seven anodes ‘internal’ to the cathode bank trains (set between the 8 cathodes in each bank), plus 2 ‘blank’ wiper frames set on the two external surfaces of the cathode bank, so that the cathodes 116 all pass between a pair of wipers 114.

Set ˜100 mm below the catholyte level (to provide a hydraulic pressure for catholyte to flow into the anode chambers), the frames of the anode chambers 115 are connected on their sides near the top and bottom of the support struts 112 to fixed piping (not shown) that withdraws Cl₂Br⁻ and any vapour from the anode chambers 115.

Provisionally, copper dendrites scraped off the cathodes 116 will be removed by screw feeders 152 set into the sumps 150 of the cell 100. Rather than being driven directly through a rod that passes through the wall of the tank, the drive motors will be set vertically above a protective lid on one side of the tank. These will drive a rotating titanium rod set vertically above the sumps/screw drives, and the motion will be translated into the horizontal via a conventional bevel gear.

Cell 100 is provisionally estimated to produce 3,449 tpa of copper at 1,000 A/m². Further test work will determine if the current density can be increased, which would in turn increase production per cell. At current design rates, a 73,000 tpa project would require 22 cells.

In summary, an operational electrowinning cell in accordance with the present invention includes:
Flat plate titanium cathodes (possibly with varying scratched growth site patterns);
Hydraulic ram-activated horizontally reciprocating cathode motion (with timer control and direct, continuous monitoring of force applied);
Anode chambers, with permeable membranes (enabling direct, continuous measurement of cell voltage);
Screw feeders and pump for continuous copper removal;
Titanium columns to capture copper product offtake;
Cl²Br⁻ recovery to re-form process liquor; and
Gas containment and handling.

As would be appreciated, the present invention provides a number of significant and commercially important advantages over conventional electrowinning cells (EWCs) in hydrometallurgical copper extraction processes. Advantages include:
Significantly reduced capital cost—with lower fabrication cost per cell and significantly fewer cells per tonne of copper production, EW tankhouse cost could be reduced by 50% to 70% when benchmarked against independent cost estimates for conventional EWCs;
Significantly reduced operating cost—with less operating labour, less frequent maintenance predicted, and reduced predicted voltage (therefore lower electricity usage), EW tankhouse operating cost could be reduced significantly;
Significantly reduced operating risk—with a much less complicated design, the inventors predict that interruptions to operations should be considerably reduced;
Significantly reduced EW tankhouse footprint—with more cathodes per cell, and therefore fewer cells per tonne of copper production, the EW tankhouse footprint could be reduced by 25% or more;
Continuous copper growth, potentially permitting even higher operating current density;
Stable operation without sudden changes to the system;
Significantly reduced anode-cathode distance, requiring lower voltage and yielding lower power consumption;
More cathodes per cell. Fewer cells required for production;
Cathodes are significantly easier and cheaper to manufacture;
Complex mechanisms (e.g. wiper and conveyor utilised in earlier process) are eliminated;
Increased cell efficiency (e.g. no ‘breaking surface’ in the catholyte, and reduced/eliminated air ingress when covered);
Contained wash reduces/eliminates air ingress during washing/drying; and
Cathodes should be easier to refresh/renew.

It will be understood to persons skilled in the art of the invention that many modifications may be made without departing from the spirit and scope of the invention. All such modifications are intended to fall within the scope of the following claims.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A halide electrowinning cell comprising:
a cathode and an anode configured for immersion in an electrolyte comprising a metal halide, whereby passing an electrical current between the cathode and the anode in use of the cell causes metallic dendrites to be electrowon at the cathode;
one or more wipers configured such that a relative movement of the cathode with respect to the one or more wipers causes the dendrites to be scraped off the cathode whilst immersed in the electrolyte; and
a driver configured to continually move the cathode relative to the one or more wipers.

2. The halide electrowinning cell of claim 1, wherein the cathode remains substantially immersed in the electrolyte during the relative movement with respect to the one or more wipers.

3. The halide electrowinning cell of claim 1, wherein the one or more wipers comprise opposing wipers configured to receive the cathode therebetween.

4. The halide electrowinning cell of claim 1, wherein the one or more wipers are static and the cathode moves relative to the one or more wipers.

5. The halide electrowinning cell of claim 4, wherein the cathode moves relative to the one or more wipers in a substantially horizontal movement.

6. The halide electrowinning cell of claim 4, wherein the cathode reciprocates between first and second positions.

7. The halide electrowinning cell of claim 6, comprising two sets of opposing wipers, located intermediate opposite ends of the cathode, whereby an entirety of the surface of the cathode is scraped upon reciprocation of the cathode between the first and second positions.

8. The halide electrowinning cell of claim 1, wherein the cathode is a flat plate cathode.

9. The halide electrowinning cell of claim 8, wherein a surface of the cathode comprises a pattern of scratches that promotes growth of electrowon metallic dendrites in a defined configuration.

10. The halide electrowinning cell of claim 1, wherein the cathode is a titanium cathode.

11. The halide electrowinning cell of claim 1, wherein the cell further comprises a sump into which metallic dendrites scraped from the cathode continuously fall.

12. The halide electrowinning cell of claim 11, wherein the sump comprises a pump or screw feeder for removing the dendrites from the cell.

13. A method for recovering a metal from an electrolyte comprising a metal halide, the method comprising passing an electrical current through the halide electrowinning cell of claim 1 in which the electrolyte is contained, and collecting the metallic dendrites scraped off the cathode.

14. A flat plate titanium cathode for use in a halide electrowinning cell, at least one of the surfaces of the cathode comprising a pattern of scratches, the scratches being deeper than a thickness of an oxide coating on the at least one of the surfaces,
whereby the pattern of scratches is determinative of a configuration of metallic dendrites that are electrowon at the cathode in use of the halide electrowinning cell.

15. The flat plate titanium cathode of claim 14, wherein the oxide coating of the cathode has a thickness of at least 3 μm.

16. The flat plate titanium cathode of claim 14, wherein the cathode is heat treated, whereby the oxide coating of the cathode has a thickness of at least 40 μm.

17. The flat plate titanium cathode of claim 14, wherein the cathode is anodized, whereby the oxide coating of the cathode has a thickness of at least 100 μm.

18. The flat plate titanium cathode of claim 14, wherein opposing surfaces of the cathode comprise the same or different patterns of scratches.

19. The flat plate titanium cathode of claim 14, wherein the pattern of scratches comprises one or more of the following: a plurality of substantially parallel scratches, a plurality of divergent and convergent scratches and scratches having different depths and widths.

20. A method for promoting the electrowinning of metallic dendrites in a predetermined configuration on a flat plate titanium cathode in a halide electrowinning cell, the method comprising causing a pattern of scratches to be formed on at least one surface of the cathode, the scratches being deeper than a thickness of an oxide coating on the surface.

21. (canceled)
